(19) United States
(12) Patent Application Publication
(10) Pub. No.: US 2006/0099951 A1
(43) Pub. Date: May 11, 2006

(54) Handover processing method in media gateways

(75) Inventor: Sung-Kyun Park, Anyang (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/269,601

(22) Filed: Nov. 9, 2005

(30) Foreign Application Priority Data
Nov. 10, 2004 (KR) KR91231/2004

(51) Int. Cl. H04Q 7/20

(52) U.S. Cl. 455/439

(57) ABSTRACT

A handover processing method in a Media Gateways (MGW) in which a Mobile Switching Center (MSC) server can perform a handover operation regardless of a switch type of the MGW by allowing a MGW only supporting a single-switch to provide the same handover processing as one supporting a multi-switch, the handover processing method comprising: the MGW receiving a termination setup message from the MSC server when one terminal (UE) performs handover to a new RNC area; generating a new termination according to the termination setup message, and checking topology information indicating a direction between two terminations; and connecting a switch between the two terminations only when the direction indicated in the topology information is set as a both-way.

### BACKGROUND OF THE INVENTION

1. Field of the Invention

The present invention relates to a mobile communications system, and particularly, to a handover processing method in a Media Gateways (MGW).

2. Background of the Prior art

In general, a Universal Mobile Telecommunication System (UMTS) is a European-type third generation mobile communications system that has evolved from a Global System for Mobile communication (GSM). The UMTS is intended to provide various mobile communication services by combining Radio Access Network (RAN) with Wideband Code Division Multiple Access (W-CDMA) based on the GSM.

The specification of the UMTS is currently developed by a standardization group called as a Third Generation Partnership Project (3GPP). The 3GPP proposes standardization that has been stepwise developed to include more improved functions, and each development step for the standardization is divided as Release (R). Among them, in a 3GPP R4, a Mobile Switching Center/Visitor Location Resister (MSCNLR) which is a core network node belonging to a circuit switched region is divided into Mobile Switching Center (MSC) servers and Media Gatewayss (MGWs).

FIG. 1 is a view illustrating an exemplary structure of UMTS system described in a typical 3GPP R4.

As illustrated in FIG. 1, the MSC server 10 is connected to the MGW 20 via an Mc interface. The MSC servers 10 are connected therebetween via an Nc interface, while the MGWs 20 are connected therebetween via an Nb interface. The MSC server 10 or the MGW 20 is connected to a Universal Mobile Telecommunications System Radio Access Network (UTRAN) via an lu interface. The MSC 10 and the MGW 20 may be connected to a Public Switching Telephone Network (PSTN) as well. Here, the UTRAN may include a Radio Network Controller (RNC) 30 and a user terminal (User Equipment: UE) 40. Therefore, the MSC server 10 includes a VLR function to perform a management of mobility of a terminal and a control for the MGW 20.

The MSC servers 10 are connected to each other using a Bearer Independent Call Control (BICC), which is a signal protocol spec between soft switches to perform a transferring of a call signal and a voice data in a public telephone network or an intelligent network to a packet-based communications network. The BICC is used for an interworking between soft switches which are used to create a next generation network. Further, the MSC server 10 is connected to the RNC 30 via a Radio Access Network Application Part (RANAP).

The MGW 20 performs a substantial switching function and an InterWorking (I/W) function of a network, and so on. The MGW 20 may additionally perform a function such as performing a conversion of a Voice over Internet Protocol (VoIP) call into a circuit switched packet as well as functions as a transcoder, an echo cancellation, a modem, and the like. A CN bearer between MGWs 20 and an lu bearer between the MGW 20 and the RNC 30 perform a signal processing using AAL2 and ALCAP. The RNC 30 is connected to the UE 40 via a radio bearer.

An operation of the UMTS system of the 3GPP R4 having such construction will now be explained.

When a call is set between two UEs 40, each MGW 20 generates a logical entity referred to as termination which processes the corresponding call, to thereafter switch two terminations generated for communications between the two UEs 40. In this state, when one of the two UEs 40 performs handover, the MGW 20 generates one more termination for the UE which has moved into another area until the handover is completely performed.

Thus, in the state that the call is ongoing between the two UEs 40, when one UE 40 has performed the handover to moved into another area, the 3GPP recommends that the MGW 20 is allowed to generate a new termination connection between the two UEs 40 even after the one UE 40 has moved into the another area in the state that the previous termination connection between the two UEs 40 is continuously maintained. That is, it is possible to provide a continuous call connection until the handover is completely performed by simultaneously maintaining two connections for one UE which performs the handover.

However, in order to allow the MGW 20 to have two connections with one terminal which performs the handover, the MGW 20 must maintain total three termination connections.

Accordingly, in order to process the handover, the MSC server 10 transmits to the MGW 20 a command for generating a new termination to allow a connection of a multi-switch among three terminations, and then sends a message, referred to as Change Flow Direction, to instruct a direction to connect the terminations. Hence, according to the instructed direction, a traffic may flow in a both-way or an one-way between any terminations, while the traffic may not flow between other terminations (isolate).

Afterwards, when the handover is terminated, the connection with two terminations that have initially been connected by the MGW 20 is disconnected, and only the connection with the new termination is maintained.

FIG. 2 is a flowchart illustrating a handover processing method in a prior art Media Gateways (MGW).

Referring to FIGS. 1 and 2, in the state that two terminals (UE1 41 and UE2 42) exist in difference areas of the RNC (30), when a call is set between the UE1 41 and UE2 42, as shown in FIG. 3, the MGW 20 generates terminations T1 and T2, respectively, and connects the two T1 and T2 with a switch so that the two UEs, UE1 41 and UE2 42 can communicate each other.

Thereafter, when the UE1 performs handover to an area of an RNC3 33 (S11), the MSC server 10 transmits ADD.request message to the MGW 20 (S10), to instruct a generation of a new termination T3 and a direction to connect each termination to each other. Accordingly, the MGW 20 generates the T3 depending on the ADD.request message and performs a multi-switch connection between the terminations T1 to T3 (S11). When the corresponding operation is completed, the MGW 20 sends ADD.replay message to the MSC server 10. At this time, the ADD.request contains such following contents.

-ADD.request (C1,topology(T2,$,one-way,T1,$,isolate),Add($))

Here, C1 is a context which denotes an association between terminations, and topology denotes a direction to be connected. For example, the topology (T2,$,one-way,T1,$,isolate) indicates that the T3 is allocated with respect to $ to be added, the one-way is set between the T2 and the $ (T3), and a connection between the T1 and $(T3) is set as the ‘isolate’. Also, the Add($) indicates that the T3 which is appropriate for such condition should be allocated.

Afterwards, just before the UE1 41 moves into the RNC3 area (during handover), the MSC server 10 transmits MOD.request message to the MGW 20 (S13 and S14) to change the multi-switch connections among the three terminations T1 to the T3. That is, just before the UE1 41 moves to the area of the RNC3 33, the MGW 20 connects the T2 and the T3 in a both-way and connects the T1 and the T2 in an one-way according to the MOD.request message (S15). When the corresponding operation is completed, the MGW 20 sends MODIFY.reply message to the MSC server 10 (S16). At this time, the MOD.request message contains such following contents.

-MOD.request(C1,topology(T2,T3, both-way,T2,T1,one-way), Modify(T3))

Here, the MOD.request denotes performing of modification, the topology (T2,T3,both-way,T2,T1,one-way) indicates that the T2 and the T3 are connected to each other in the both-way, the T2 and T1 are connected to each other in the one-way, and the Modify(T3) denotes the performing of modification regarding the T3 to be appropriate for such condition.

When the UE1 41 completely moves to the area of the RNC3 33 (after handover), the MSC server 10 transmits SUBTRACT.request message to the MGW 20 to request a subtraction of the T1 among the terminations T1 to T3 being connected. Therefore, the MGW 20 subtracts the T1 according to the SUBTRACT.request message, and maintains the connection between the T2 and T3. When the corresponding operation is completed, the MGW 20 sends SUBTRACT.replay message to the MSC server 10.

As aforementioned, in the prior art, when one of two UEs performs handover while a call is ongoing between the two UEs, the new termination T3 is generated in addition to the previously-generated terminations T1 and T2, to thereafter connect the three terminations T1 to T3 using the multi-switch. At this time, the three terminations T1 to T3 can be connected to one another, and direction have been set between connected terminations based on Change Flow Direction.

However, the prior art can be operated only when the MGW provides the multi-switch, but many MGWs only support a signal switch. Accordingly, in the prior art, while a call is ongoing between two UEs, if one UE performs handover, there has been no appropriate way to solve this problem.

### BRIEF DESCRIPTION OF THE INVENTION

Therefore, an object of the present invention is to provide a handover processing method in a Media Gateways (MGW) capable of performing a multi-switch connection for processing handover even in a MGW which does not support the multi-switch.

To achieve these and other advantages and in accordance with the purpose of the present invention, as embodied and broadly described herein, there is provided a handover processing method in a Media Gateways comprising: a Media Gateways (MGW) receiving a termination setup message from a Mobile Switching Center (MSC) server when one terminal performs handover to a new RNC area; generating a new termination according to the termination setup message, and checking information regarding a direction between two terminations; and performing a switch connection between two terminations only when the direction indicated in the information is set as a both-way.

Preferably, the termination setup message is one of ADD.request message and MOD.request message.

Preferably, the information indicating the direction between the two terminations is topology information or Charge Flow Direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a typical UMTS system described in 3GPP R4;

FIG. 2 is a flowchart illustrating sequential steps of an exemplary handover processing method in a Media Gateways (MGW) of 3GPP R4;

FIG. 3 is a view illustrating a connected state between terminations of MGW before handover in FIG. 2;

FIG. 4 is a view illustrating a generation of a new termination when initially performing handover in FIG. 2;

FIG. 5 is a view illustrating a connected state between the new termination and the previously-generated terminations during handover in FIG. 2;

FIG. 6 is a view illustrating a connected state between terminations of MGW after handover in FIG. 2;

FIG. 7 is a flowchart illustrating sequential steps of an exemplary handover processing method of a Media Gateways (MGW) according to the present invention;

FIG. 8 is a view illustrating a connected state between terminations of MGW when initially performing handover in FIG. 7;

FIG. 9 is a view illustrating a generation of a new termination during handover in FIG. 7;

FIG. 10 is a view illustrating a connected state between terminations of MGW after handover in FIG. 7; and

FIG. 11 is a conceptual view comparing a handover processing methods in a Media Gateways according to the prior art and that according to present invention.

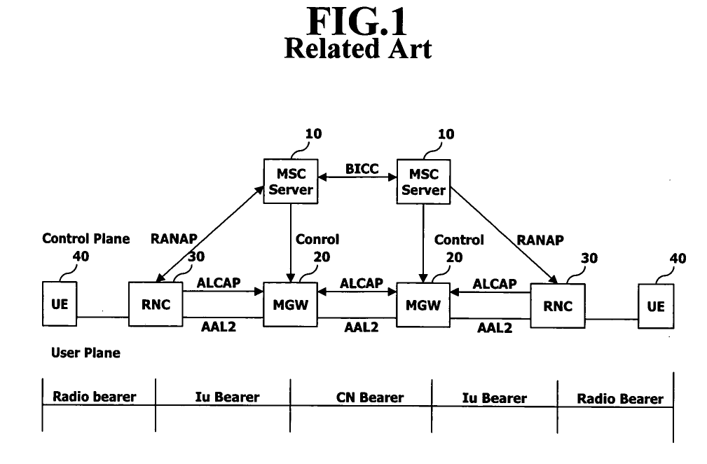

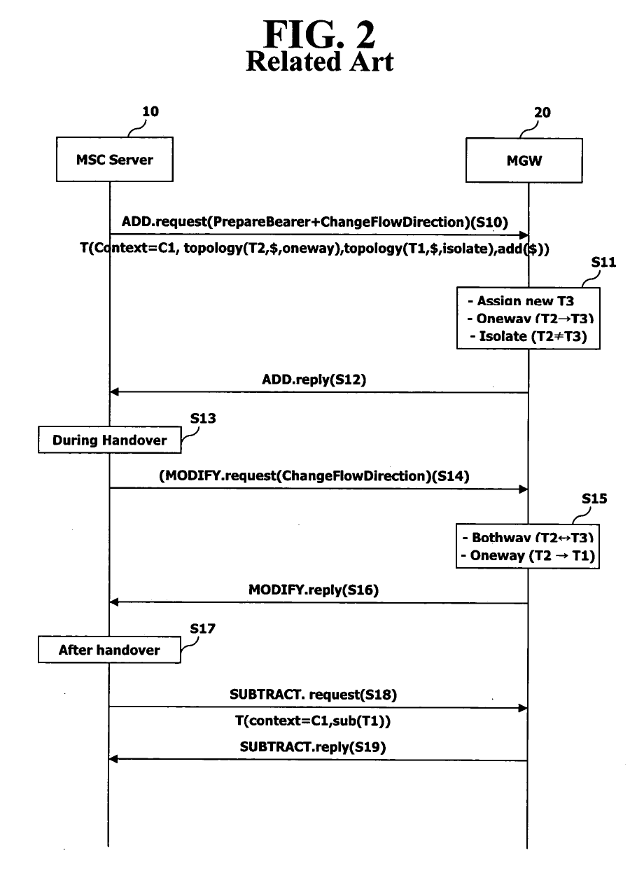

### DETAILED DESCRIPTION OF THE INVENTION

Reference will now be made in detail to the preferred embodiments of the present invention, examples of which are illustrated in the accompanying drawings.

The present invention provides a method in which a Mobile Switching Center (MSC) server can perform a handover operation regardless of a multi-switch or single switch of a Media Gateways (MGW) by providing the same handover processing as using the multi-switch even in a MGW providing the single switch. For this purpose, in the present invention, the prior art operation that a Change Flow Direction (including a plurality of topology information) message is used to indicate a direction between terminations is modified so as to enable processing of the Change Flow Direction even using a single-switching method.

That is, when a stream mode of each termination is inactive, the MGW must connect the terminations existing within one context. Considering this, in the present invention, a topology is checked in a MGW switching rule, to thus connect a switch only when a termination connection is set as a both-way. In other words, when topology information which indicates a direction between two terminations using a termination setup message is received, the MGW connects the switch between the two terminations only when the connection between the two terminations is set to have the both-way, while the switch is not connected in the other cases. Therefore, the MGW has only one connection at a certain moment, and accordingly can obtain an effect expected when using a multi-switching method even in a single-switching method. Preferably, the termination setup message may be one of ADD.request message and MOD.request message.

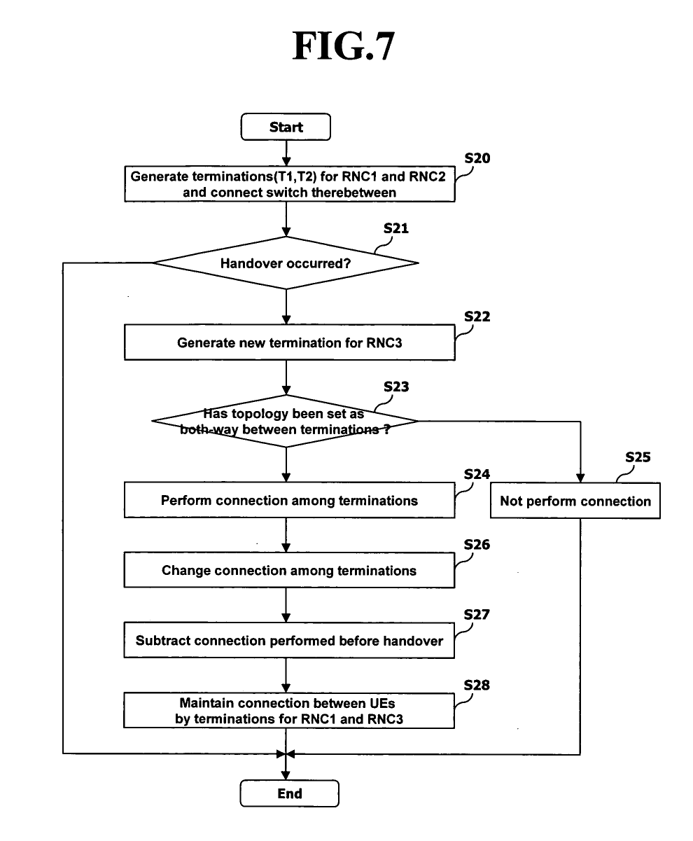

FIG. 7 is a flowchart illustrating a handover processing method in a MGW according to the present invention.

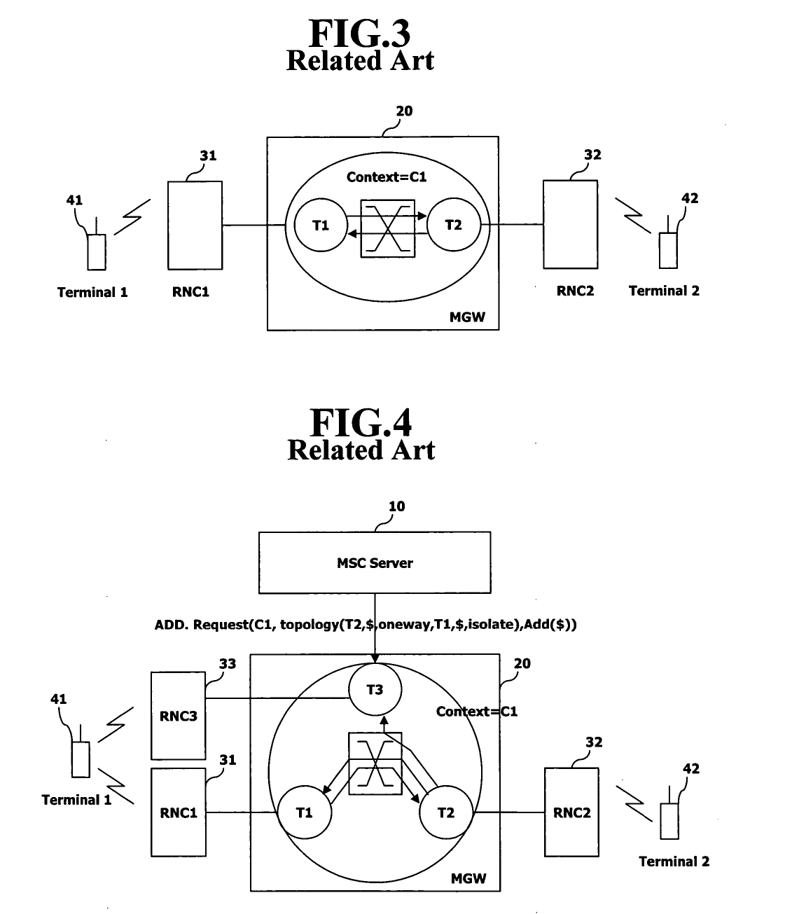

As illustrated in FIG. 7, in the state that the two UEs 41 and 42 exist within an RNC1 31 and an RNC2 32, respectively, if the call is set between the two UEs 41 and 42, as illustrated in FIG. 3, each MGW 20 generates the terminations T1 and T2 to thereafter connect a switch between the two terminations T1 and T2 (S20).

Then, the MSC server 10 checks whether the UE1 41 performs handover (S21). For example, when the UE1 41 performs the handover to the area of the RNC3 33, the MSC server 10 transmits ADD.request message to the MGW 20 to make the MGW 20 generate the new termination T3 according to the ADD.request message.

Accordingly, the MGW 20 generates the new termination T3 according to the ADD.request message (S22), and checks a topology contained in the ADD.request message to determine whether the termination connection is set as a both-way (S23). If it is determined to be set as the both-way, the MGW 20 connects the switch between the corresponding terminations (S24), while the switch connection is not performed if it is determined to be set as an one-way or an ‘isolate’ (S25).

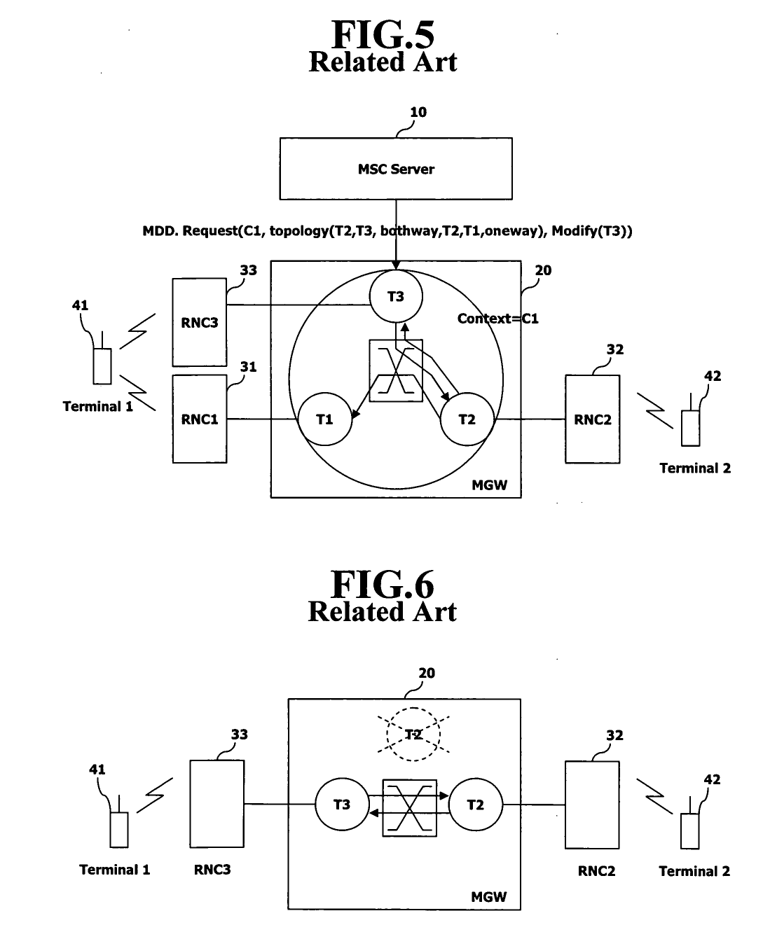

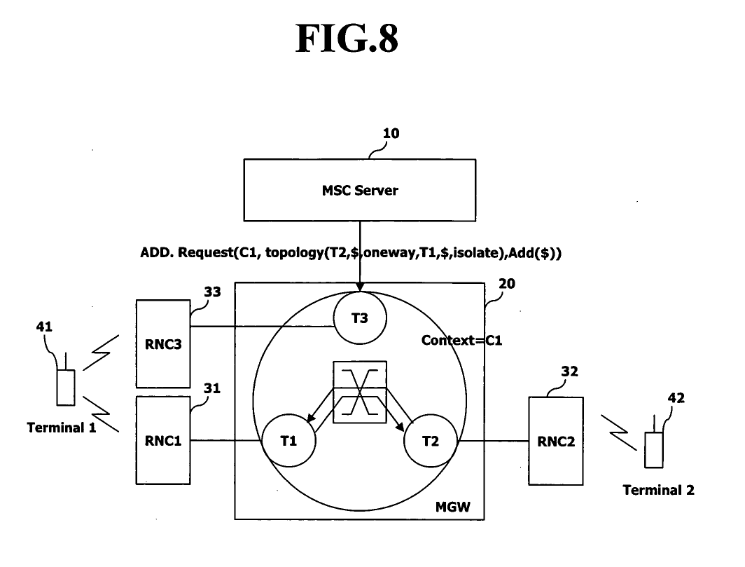

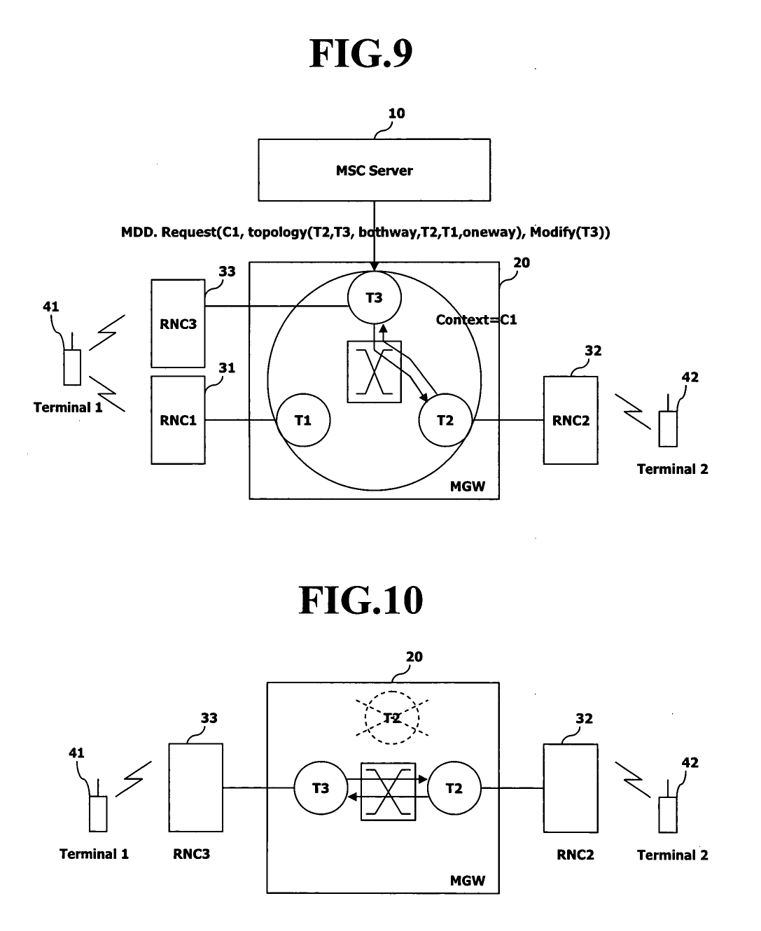

For example, when the handover is initiated, as illustrated in FIG. 4, the prior art MGW 20 has simply connected the T1 with the T2 in the both-way according to Change Flow Direction of the ADD.request message, and has connected the T2 with the T3 in the one-way. However, in the present invention, the MGW 20, as illustrated in FIG. 8, only connects the T1 with the T2 in the both-way according to each topology information, and does not connect the T2 with the T3. Afterwards, the MSC server 10 transmits MOD.request message instructing a change of the connections of the terminations to the MGW 20 during handover. The MGW 20 rechecks topology information contained in the MOD.request message to change the connection of the terminations T1 to T3 (S26). Accordingly, when the MOD.request message contains such contents, namely, C1,topology(T2,T3,both-way,T2,T1,one-way),Modify(T3), the MGW 20 connects the T2 with the T3 in the both-way and does not connect the T2 with the T1 as illustrated in FIG. 9, rather than connecting the T2 with the T3 in the both-way and connecting the T2 with the T2 in the one-way as illustrated in FIG. 5 according to the prior art.

Afterwards, when the UE1 41 finally moves to the area of the RNC3 33 to thus complete the handover, the MSC server 10 transmits SUBTRACT.request message to the MGW 20 to request a subtraction of the T1 among the terminations T1 to T3 being connected (S18). Hence, as illustrated in FIG. 10, the MGW 20 subtracts the T1 according to the SUBTRACT.request message, and maintains only the connection between the T2 and the T3.

Thus, according to the operations of connection/disconnection (release) of switches among the terminations T1 to T3 as illustrated in FIGS. 8 to 10, the MSC server 10 can determine as if the MGW 20 supports the multi-switch. The MGW 20 takes very short time to connect (or disconnect) the single switch, and thus the UE1 41 which has moved by performing handover can not actually be aware of this connection (or disconnection).

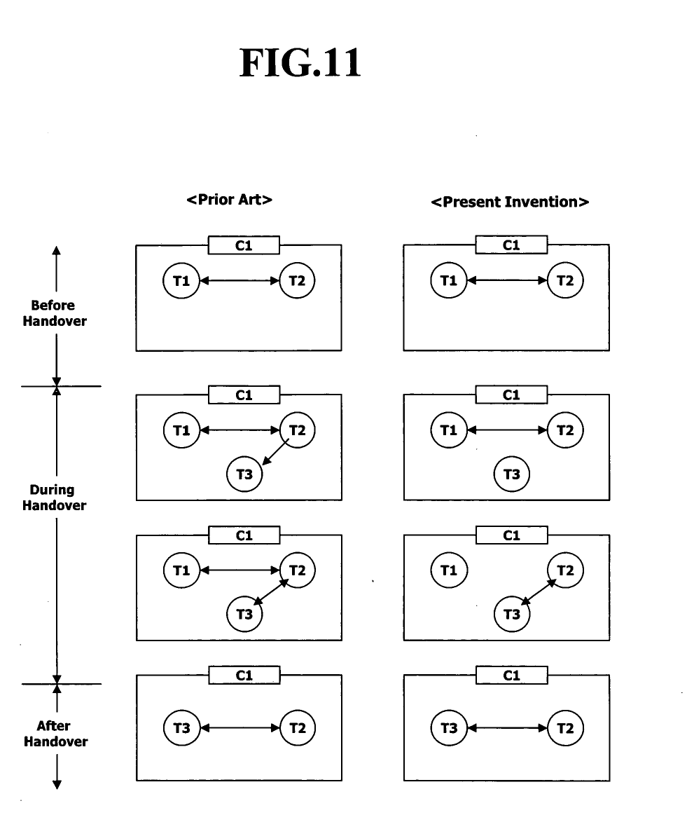

FIG. 11 is a view comparing termination connections during handover according to the prior art with those according to the present invention.

Referring to FIG. 11, in the prior art and the present invention, the operations performed before handover and after handover are the same as each other, but the termination connections during handover are different from each other. This is because, in the present invention, the switch between two terminations is connected only when the connection between the two terminations is set as the both-way, and is not connected therebetween in other cases.

As described above, in the present invention, when the MSC server requests the multi-switch connection to process handover, even the MGW which does not support the multi-switch can effectively perform the termination connection for the corresponding handover. In particular, in the present invention, the function performed in the system using the multi-switch can be performed in the system using the single-switch, and thus a high-cost of multi-switch equipment is not required, thusly resulting in reducing a fabricating cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A handover processing method in a Media Gatewayss (MGW) which connects two terminations for two terminals (UEs) according to the control of a Mobile Switching Center (MSC) server to perform a call connection, comprising:
the MGW receiving a termination setup message from the MSC server when one terminal performs handover;
generating a new termination according to the termination setup message, and checking information indicating a direction between two terminations; and
performing a switch connection among the terminations according to the checked result.

2. The method of claim 1, wherein the MGW connects a switch between two terminations when the information regarding the direction between two terminations is set as a both-way, and does not connect the switch between the two terminations when the information is set as an one-way.

3. The method of claim 1, wherein the termination setup message is one of ADD.request message and MOD.request message.

4. The method of claim 1, wherein the information indicating the direction between the two terminations is the topology information or a Change Flow Direction.

5. The method of claim 1, wherein the MGW maintains only a connection with a new termination after handover.

6. The method of claim 1, wherein the MGW only connects terminations for first and second terminals (UEs) according to the ADD.request message when initiating handover.

7. The method of claim 1, wherein the MGW only connects the termination for the second terminal with the new termination according to the MOD.request message during handover.
